(19) United States
(12) Patent Application Publication
(10) Pub. No.: US 2004/0100053 A1
(43) Pub. Date: May 27, 2004

(54) Steering structure of a scooter with twin front wheels

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/302,876

(22) Filed: Nov. 25, 2002

(51) Int. Cl. B62M 1/00

(52) U.S. Cl. 280/87.041; 280/87.042

(57) ABSTRACT

A steering structure for a scooter with twin front wheels includes a front fork to secure a handle and a frame thereon, a pair of connectors, a pair of torque springs and a rod. The front fork has a pair of posts extending from respective sides thereof, adapted to connect with a connector, respectively. Each connector comprises a trough to accommodate a torque spring therein. Two ends of each torque spring are located in the front fork and the connectors. Both the connectors are pivoted with the rod and wheels. When a user riding on the scooter leans his/her body or presses the handle with force, the wheels deviate towards one side, whereas the torque springs provide a constant urging force to restore the wheels towards its original position.

### FIELD OF THE INVENTION

This invention relates to a steering structure of a scooter with twin front wheels, and more particular to a scooter being able to turn with a small angle in a smooth manner and restore to its original position.

### BACKGROUND OF THE INVENTION

Conventional scooters are made with two wheels design, with one at the front and the other at the rear of the board. Now there are a few designs with two front wheels and a handle extending from the front wheel for a user to hold and control the direction and to provide a better balance to the user, so that the user may hold the handle with one foot stepping on the board, while the other foot pushing the board to move forward. This design provides a convenient speed as well as balance. However, due to the two wheels are in secured under the board in a straight line, the turn requires a wide angle and it is easy to get one wheel lifted when making turn.

In view of this, the inventor has invented the present invention to improve the shortcomings.

### SUMMARY OF THE INVENTION

It is the primary object of the present invention to provide a steering structure of a scooter with twin front wheels, which requires a narrow angle to turn.

It is another object of the present invention to provide a steering structure of a scooter with twin front wheels, which is more safety.

It is a further object of the present invention to provide a steering structure of a scooter with twin front wheels, which is more firm and lasts longer.

### BRIEF DESCRIPTION OF THE DRAWINGS

FIG. 1 is an exploded view of the present invention;

FIG. 2 is a perspective view of the present invention;

FIG. 3 is a front view of the present invention, partially sectioned;

FIG. 4 is a partially enlarged view of FIG. 3;

FIG. 5 is a front view of the present invention in turning status with partially sectioned;

FIG. 6 is a partially enlarged view of FIG. 5, and

FIG. 7 is a front perspective view of FIG. 5

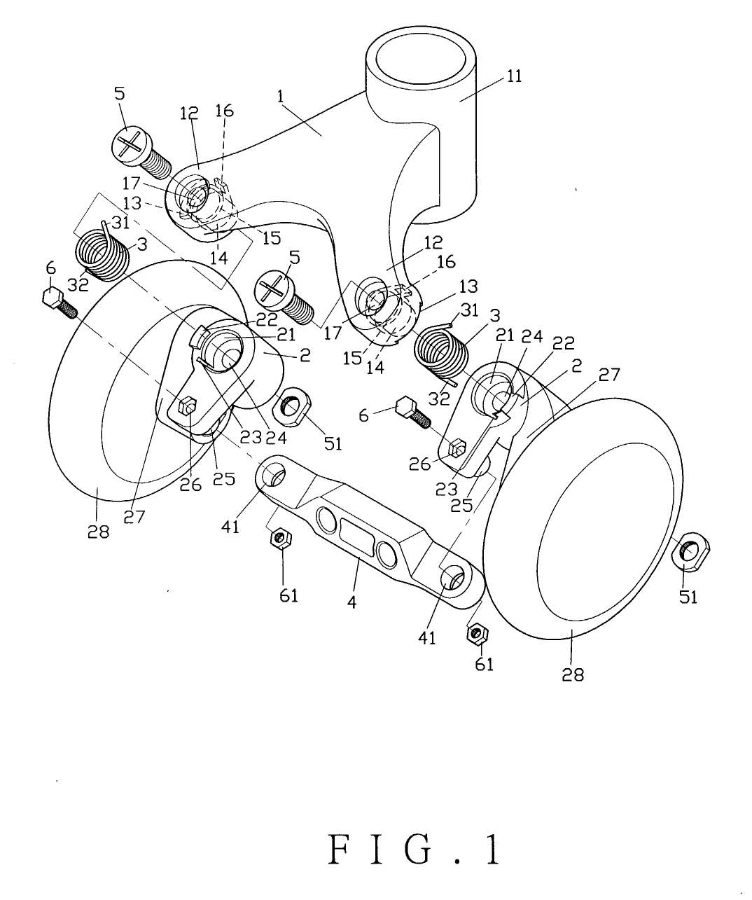

### DETAILED DESCRIPTION OF THE PREFERRED EMBODIMENT

A steering structure of a scooter with twin front wheels of the present invention comprises a front fork 1, a pair of connectors 2, two torque springs 3, a rod 4, two bolts 5 and nuts 51, two bolts 6 and nuts 61, a handle 7 and a frame 8.

The front fork 1 comprises a strut 11 at its rear end for the handle 7 and the frame 8 to secure therein, a pair of arms 12 extending forwardly therefrom. Each of the arms 12 has a slot 13 at the lower outer end and a post 14 at the lower inner end thereof. The post 14 has a circular trough 15 with a groove 16 thereat. The slot 14 also comprises a through hole 17 therein.

The connectors 2 are secured to the two arms 12 of the front fork 1. Each of the connectors 2 has a trough 21 with a block 22 protruding from the top and a groove 23 on one side thereof. The bottom end of the trough 21 has a hole 24. Each of the connectors 2 has a connecting arm 25 with a hole 26 therein and a connecting block 27 on one side thereof to be connected with a wheel 28.

Each of the torque springs 3 is placed in the trough 21 of the connector 2 and comprises two ends 31 and 32.

The rod 4 has a pair of holes 41 at respective ends to be connected with the two connecting arms 25 of the connectors 2.

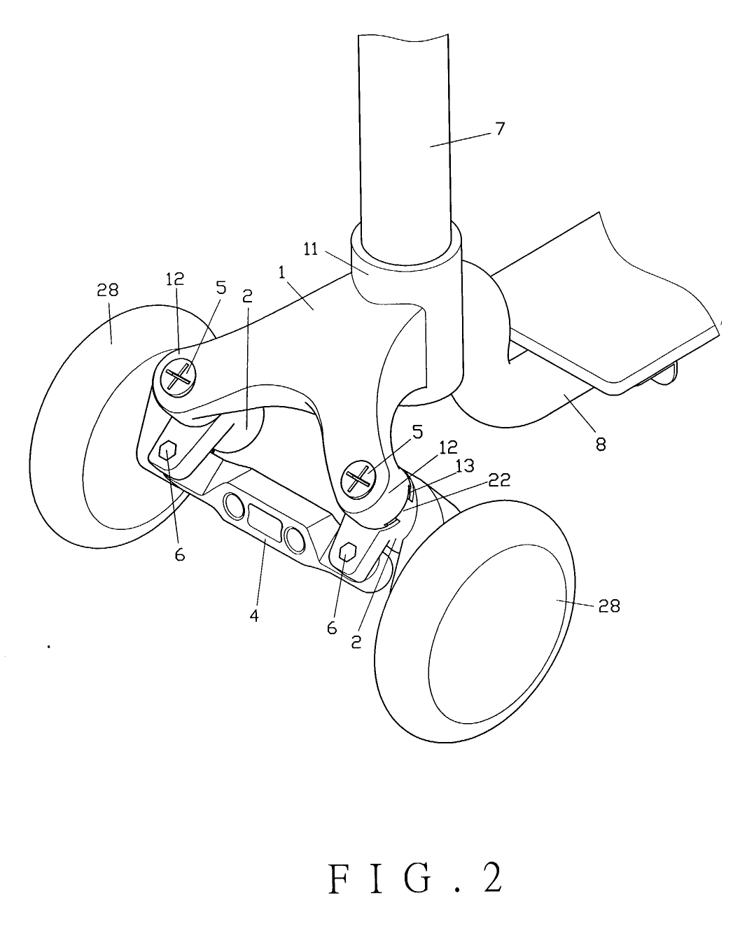

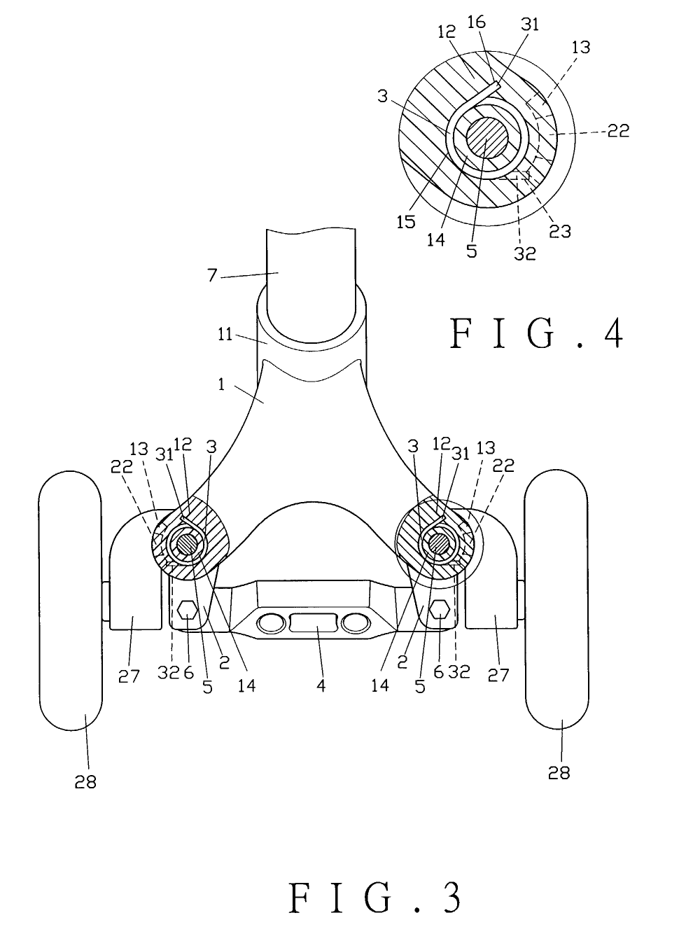

To assemble the present invention, as shown in FIGS. 2 through 4, the two torque springs 3 are placed into the troughs 21 of the two connectors 2 with one end 32 of each torque spring 3 clamped into the groove 23. Both the posts 14 are placed into the troughs 21 of the connectors 2 thereafter, and each of the torque springs 3 is forced into each circular trough 15 and sleeved onto the post 14, whereas the other end 31 of each torque spring 3 is located in the groove 16. The block 22 of each the connector 2 is located in the center position of the slot 13 of the arm 12. Each the bolt 5 is inserted through the through hole 17 of the post 14 and the hole 24 of the trough 21, and secured by the nut 51 from the other side thereof. This connects the two connectors 2 with the two arms 12 of the front fork 1 in a movable manner, respectively. The connecting arms 25 of the two connectors 2 are placed into the respective holes 41 of the rod 4 and secured with the bolts 6 and the nuts 61. This completes connection of the connecting arms 25 of the connectors 2 to the rod 4.

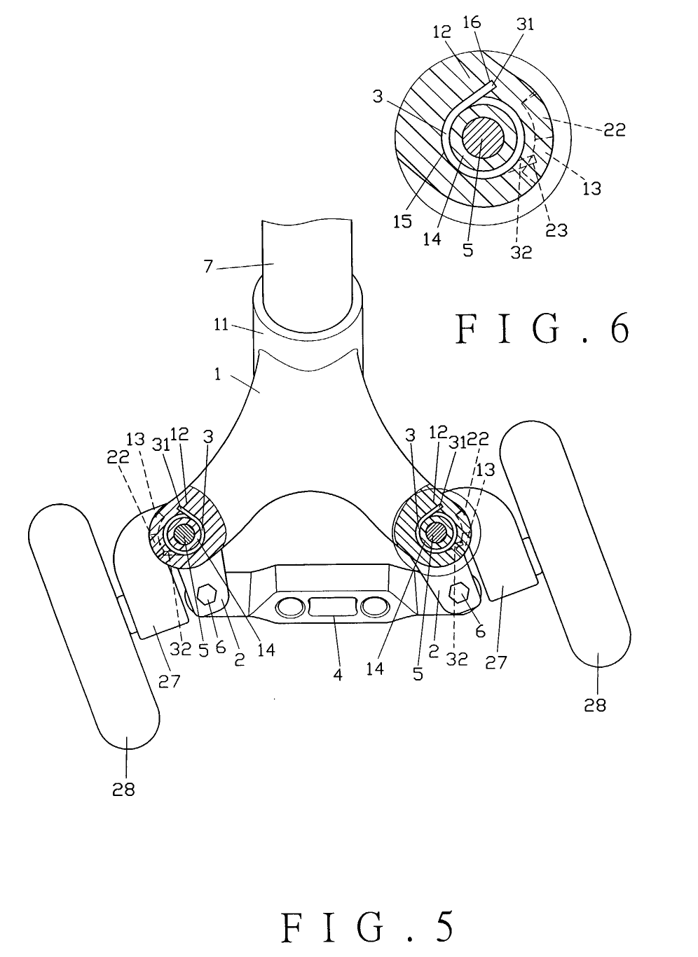

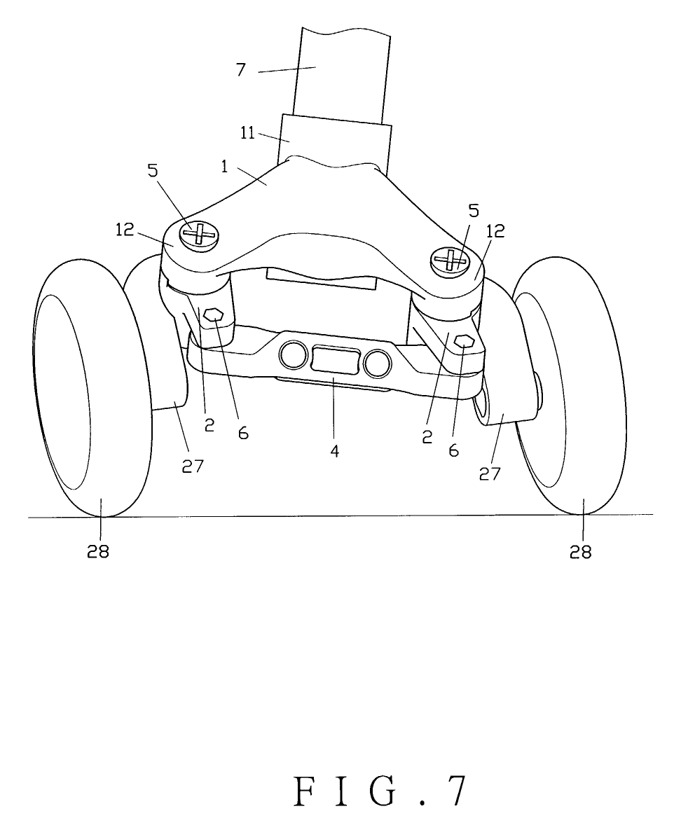

To operate the present invention, as shown in FIGS. 5 through 7, when turning the scooter to the left, a user may either lean towards left with his/her body or press the left side of the handle 7. This movement makes the front left wheel bears more pressure, and causes the left wheel deviated left direction, whereas the right wheel is also linked to turn leftward. When both wheels turn left, the connectors 2 also turn left, and whereas the two ends 31 and 32 of the torque spring 3 in the left trough 21 are twisted by the groove 16 of the front fork 1 and the groove 23 of the connector 2. Further, the turning angle of the scooter is confined by the blocks 22 of the connectors 2 within the slots 13 of the front fork 1 from overturning. When the wheels complete its turning movement, and are ready to go back to its original position, the user may maintain a straight position without applying any force against the left side of the handle 7, whereas the torque spring 3 urges the handle 7 to back its original position. When it is desired to turn right, the user may lean his/her body to the right and apply force on the right side of the handle 7.

I claim:

1. A steering structure of a scooter with twin front wheels comprising a front fork, a pair of connectors, a pair of torque springs and a rod, wherein
said front fork comprising a strut at a rear end and a pair of arms extending forward, each said arm comprising a post extending downward, each said post comprising a circular trough with a groove thereat, and each said post comprising a through hole therein;
each said connector being secured to said relative post of said front fork, and comprising a trough, said trough comprising a groove on one side thereof and a hole at bottom end thereof, said connector further comprising a connecting arm at a front end, said connecting arm comprising a hole therein, said connector further comprising a connecting block at one side thereof, adapted to connect with wheels thereat;
each said torque spring being accommodated in said trough of said connector and comprising two ends being secured to said grooves of said front fork and said connector;
said rod being secured onto said connecting arms of said connectors, and comprising a hole at respective ends thereof.

2. The steering structure of a scooter with twin front wheels, as recited in claim 1, wherein each said arm of said front fork comprises a slot at an outer ridge, and said trough of each said connector comprises a block to be located within said slot.
